(19) United States
(12) Patent Application Publication
(10) Pub. No.: US 2008/0155126 A1
(43) Pub. Date: Jun. 26, 2008

(54) Auto-Configuration Of Daisy-Chained Devices

(75) Inventor: Tushara K. Swain, Orissa (IN)

Correspondence Address: TEXAS INSTRUMENTS INCORPORATED, P O BOX 655474, M/S 3999, DALLAS, TX, 75265, US

(73) Assignee: Texas Instruments, Inc., Dallas, TX (US)

(21) Appl. No.: 11/615,265

(22) Filed: Dec. 22, 2006

(51) Int. Cl. G06F 15/16

(52) U.S. Cl. 709/251

(57) ABSTRACT

A method, system and device are disclosed for auto-configuration of a daisy-chain system of a plurality of serially inter-connected devices. The method includes receiving at least one rule for a configuration domain. The method further includes fetching configuration information from at least one device in the system. The method additionally includes defining the configuration domain based on the at least one rule and the configuration information, applying the configuration domain to each device in the system.

### CROSS-REFERENCE TO RELATED APPLICATIONS

This application includes subject matter that may be related to one or more of the following applications, which are hereby incorporated by reference:

U.S. patent application Ser. No. ______, filed ______ 2006, entitled “Device and Method for Discovery, Detection, and Management of Daisy-chained System Topology,” by Tushara Swain (Atty Docket No. TI-39462); and

U.S. patent application Ser. No. ______, filed ______ 2006, entitled “Control Token Based Management of Daisy-chained System Topology,” by Tushara Swain (Atty Docket No. TI-39923).

### BACKGROUND

“Daisy-chain stacking” is a wiring scheme for inter-connecting similar devices, such as in a Local Area Network (“LAN”). One example of daisy-chain device installations are Internet Protocol (“IP”) telephones and Ethernet switches in a LAN. Some networks typically involve configuration and management activities. Configuration may include, for example, setting up one or more IP telephones and/or Ethernet switches in a LAN, and management may include, for example, adding or removing telephones, or altering various parameters or operational software for operating the telephones in the LAN. In various installations, a daisy-chain may include hundreds of devices, making configuration and management of the devices burdensome and/or complex. At present, configuration information for each device in a LAN is stored in some form of storage, such as flash memory in each device, and may be provided initially and then altered subsequently by manual modifications either locally or remotely over the LAN. Such configuration activities are cumbersome.

### SUMMARY

Accordingly, an illustrative method is disclosed for auto-configuration of a daisy-chain system of a plurality of serially inter-connected devices can include receiving at least one rule for a configuration domain. In one embodiment, a method can further include fetching configuration information from at least one device in the system. Such a method can additionally include defining the configuration domain based on at least one rule and the configuration information, and further applying the configuration domain to each device in the system.

An illustrative daisy-chain system for auto-configuration is disclosed. The system can include a plurality of auto-configuring devices serially inter-connected together, wherein one device of the plurality of auto-configuring devices is a master device. Each auto-configuring device of the system includes an ethernet switch having at least two ports, and a control logic. The control logic is operable to receive at least one rule for a configuration domain, and fetch configuration information from at least one device in the system. The control logic is further operable to define the configuration domain based on the at least one rule and the configuration information, and apply the configuration domain to each device in the system.

An illustrative auto-configuring device is also disclosed. The auto-configuring device can include an Ethernet switch having at least two ports, a storage storing configuration information, and a control logic. The control logic is operable to receive at least one rule for a configuration domain, fetch configuration information from the storage, define the configuration domain based on the at least one rule and the configuration information, and forward the configuration domain to any external device operably coupled to the device by one of the ports.

### BRIEF DESCRIPTION OF THE DRAWINGS

For a detailed description of exemplary embodiments of the invention, reference will now be made to the accompanying drawings in which:

FIG. 1 shows a block diagram of a daisy-chained system in accordance with one or more embodiments.

FIG. 2 shows a block diagram of an illustrative device which may be used in the daisy-chained system of FIG. 1 in accordance with one or more embodiments.

FIG. 3 shows a flow chart of a method of token-based management of daisy-chained system topology in accordance with one or more embodiments.

FIG. 4 shows a flow chart of a method of auto-configuring devices in a daisy-chain system in accordance with one or more embodiments.

FIG. 5 shows a flow chart of a method of obtaining valid configuration information and establishing a common configuration domain in accordance with one or more embodiments.

FIG. 6 shows a flow chart of an illustrative embodiment of a method of auto-configuring a system of daisy-chained IP telephones in accordance with one or more embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to an operative collection of two or more parts and may be used to refer to an entire system, a portion of such a system, a computer network, a portion of a computer network, or a series of daisy-chain ethernet based devices.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In many installations of daisy-chained devices, configuration of devices without the system and method of the present disclosure is performed manually on each device individually. Individual, manual configuration makes updates or changes in configuration very labor intensive. In such installations, each device would be managed as a separate entity, typically through remote management over Simple Network Management Protocol-Internet Protocol (“SNMP-IP”) based architecture. A method and system for auto-configuration of devices in a daisy-chained system according to embodiments of this disclosure makes configuration as well as management (i.e., updates of operational parameters and software) more efficient.

Generally, valid configuration information may be obtained from, for example, one device in the chain, and the other devices in the chain may be configured according to the same valid configuration information. A control token management method ensures uniformity of configuration across the system. A set of rules may be established to govern the system of daisy-chained devices, thereby simplifying the configuration of parameters across the system according to a common set of configuration information. As a result, a user need only configure one device, and the remaining devices may be similarly configured automatically.

A “common configuration domain” is created when devices daisy chained together are configured with the same or similar parameters. In a common configuration domain, all devices are preferably configured identically or at least similarly. Disclosed herein are methods and mechanisms for auto-configuration of devices in the common configuration domain including fetching configuration information from one device in a common configuration domain, and configuring the remainder of the devices according to the same configuration information. The configuration of the devices in the common configuration domain may be governed by a set of rules derived for each parameter in the configuration domain.

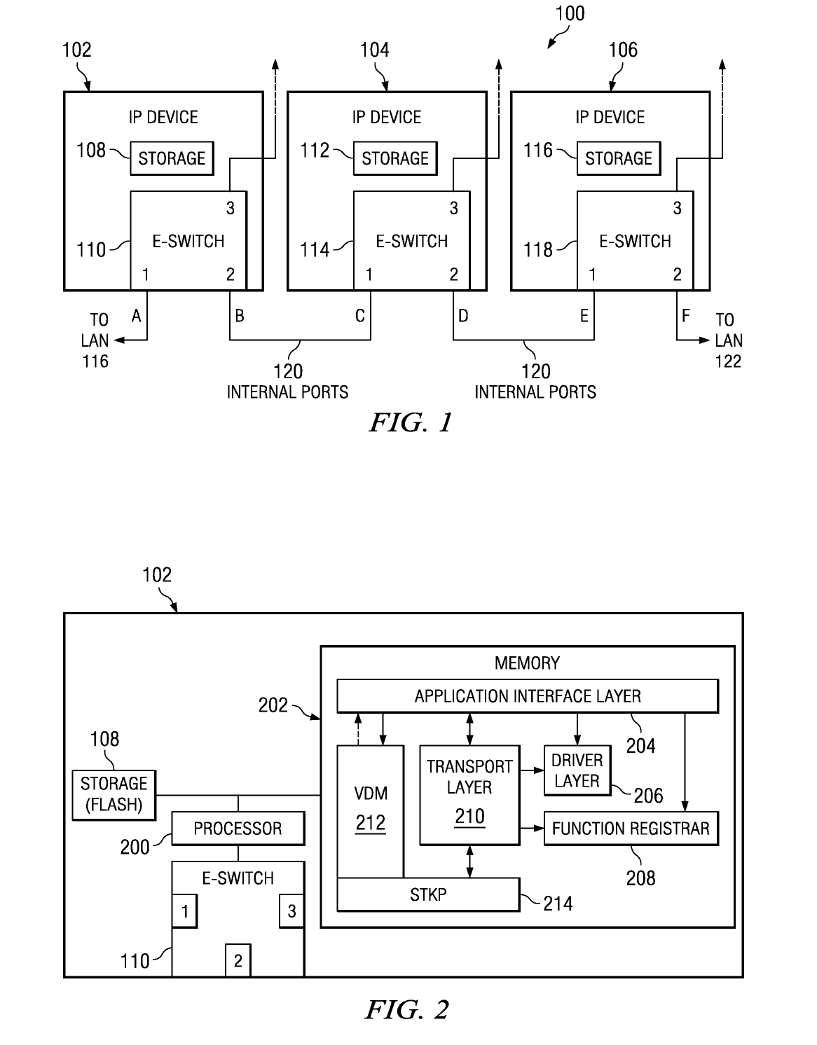

FIG. 1 shows a block diagram of three similar devices, Device 102, Device 104, and Device 106 inter-connected in a serial fashion to form a daisy-chained system 100. While three devices are shown here for illustrative purposes, any number of devices may be inter-connected together in such a fashion as shown, or otherwise as is well known by one of skill in the art. Likewise, the devices may be IP telephones or any other Ethernet based device. Port A of Device 102 is connected to the external world, i.e., to a LAN or PC 116. Similarly Port F of Device 106 is connected to the external world 122. Port A and Port F thus define the boundaries of the daisy-chained system 100, and may be referred to as the “boundary ports,” while the remaining ports (Ports B, C, D, and E) are referred to as “internal ports” 120. A stacking protocol, implemented in software stored on each device, executes within each of the devices. The stacking protocol comprises a means by which the daisy-chain system topology is discovered, each device is enumerated, and a master device is defined.

Specifically, the stacking protocol determines the boundaries of the system, and selects one of the boundary devices to be the master device, as described in various embodiments of related applications U.S. patent application Ser. No. ______, filed ______ 2006, entitled “Device and Method for Discovery, Detection, and Management of Daisy-chained System Topology,” by Tushara Swain (Attorney Docket No. TI-39462), and U.S. patent application Ser. No. ______, filed ______ 2006, entitled “Control Token Based Management of Daisy-chained System Topology,” by Tushara Swain (Attorney Docket No. TI-39923). The master device is assigned ownership of a “control token” that is used to ensure uniformity of configuration in the daisy-chained system. The master device may additionally, in various embodiments, apply a common set of configuration information to each device in the daisy-chained system, thereby creating, for example, a common configuration domain in the system.

Each device 102, 104, 106 includes storage 108, 112, and 116 respectively such as a flash memory or other form of non-volatile storage such as a hard drive, any form of read-only memory (ROM), or any type of magnetic storage device. Each device 102-106 also includes an Ethernet switch 110, 114, 116 respectively that preferably has at least two ethernet ports, although more than two ports are possible. Devices such as TNETV1050 or TNETV1055 IP telephones provided by Texas Instruments may be used.

Each port A-F has an associated link status that is indicative of whether the port is operational. The link status of a given port is reflected in one or more link status bits for that port. If a device that is operational (configured and functional) and turned on, the link status bits for each of its ports will indicate that the port is “UP.” If, however, the device is not operational, either because it is not properly configured or is powered off, the link status bits for each of its ports will indicate that the port is “DOWN.”

The topology of the daisy-chain system changes dynamically with the addition or removal of a device in the chain. Any addition or removal of a device changes the link status of the port where the device is added or removed, and thereby causes a change in the existing daisy-chain system topology. Specifically, when a device is added or removed, the link status changes for its own port that is coupled to the rest of the daisy-chain system. For example, if Device 106 were added to the daisy-chain of FIG. 1, the link status for port E, where it couples to the other devices, would change. Simply powering up or powering down a device may also change the system topology, because doing so changes the link status of the ports in the affected device. If a device is powered up or a new device is added to the daisy-chain system, the link status of the port that couples the device to the daisy-chain system changes from “DOWN” to “UP.” Similarly, if a device is removed, the link status of the port that had coupled the device to the daisy-chain system changes from “UP” to “DOWN.”

FIG. 2 shows a block diagram device 102 of the daisy-chained system of FIG. 1, illustrating the software architecture that carries out methods of various embodiments of this disclosure. The embodiment shown in FIG. 2 may apply to all such devices 102-106. The device 102 includes the storage 108 that stores the configuration information for the device 102. The device 102 also includes the ethernet switch 110, or “e-switch”, having three ports 1, 2 and 3 in the embodiment of FIG. 2. The device 102 also includes a processor 200 that executes software stored in a memory 202 that carries out various methods in accordance with embodiments of this disclosure. The software architecture that carries out methods according to this disclosure includes an Application Interface Layer 204, a Driver Layer 206, a Function Registrar 208, a Transport Layer 210, a Virtual Device Manager (“VDM”) 212, and a Stacking Protocol (“STKP”) 214, each of which will be discussed in turn herein. The virtual device information on any individual device in the daisy-chain is maintained locally with the help of the Stacking Protocol 214, and may be obtained by querying the VDM 212, which will be discussed in further detail below.

The Application Interface Layer 204 is software abstraction layer. If an upper layer attempts to send a packet on any of the ports, the layer will call an Application Interface Layer 204 function with arguments “port” and “address of packet buffer.” The Application Interface Layer's 204 internal implementation resolves it to device id and port number with the help of virtual device software architecture and sends the packet to the appropriate device identifier and port in the daisy-chain system.

The Driver Layer 206 consists of actual driver APIs. The Driver Registrar (not shown) of the Driver Layer 206 maintains a mapping of the driver APIs with numbers. In various embodiments, this mapping may be same for all devices in the daisy-chain. In an example, it is desirable to set a particular feature of a particular port and particular device identifier by setting a value. A certain driver API in the Driver Layer 206 is registered with a given number for that feature. A configuration packet may be directed to the device that includes the number for the feature, the port identifier and the device identifier, and when the transport layer 210 at that device receives the packet, the packet is decoded and determined to be a configuration message. The device may then reference its own Driver Registrar to determine which driver API corresponds to the number in the packet, and then call the identified driver API with the arguments being the port number and value passed in the configuration message.

The Function Registrar 208 builds a database of functions (or APIs) that may be executed by processor 200. The APIs are stored with a module identifier and a function identifier according to a function index. The API functions, when executed by the processor, perform various functions such as managing or configuring the device 102.

Packet framing for configuration PDUs is performed at the Transport Layer 210. The Transport Layer 210 prepends the multicast address, source address and type of message to each command message. The Transport Layer 210 also builds configuration messages based on information obtained from the VDM, as well as decodes incoming configuration messages. The Transport Layer 210 also sends and receives command Protocol Data Units (“PDUs”) to and from the Stacking Protocol 208. After receiving a PDU, the Transport Layer 210 determines whether a configuration packet is to be further forwarded to other ports, which will be discussed in more detail below.

The VDM 212 interacts with the Stacking Protocol 214 to update the device information. The VDM 212 includes a self-device identifier. Any change to the stacking state (i.e., a device's own status in the overall system topology) is reflected in the VDM 212.

The Stacking Protocol 214 discovers the daisy-chain system topology in a dynamic manner, as discussed in greater detail below. The Stacking Protocol 214 is also used as a transport medium for configuration PDUs once the system topology has been discovered and the daisy-chained system is managed by the Virtual Device Manager 212. The Stacking Protocol 214 also determines which device in the daisy-chain system is the master device, and assigns ownership of the control token to the master device.

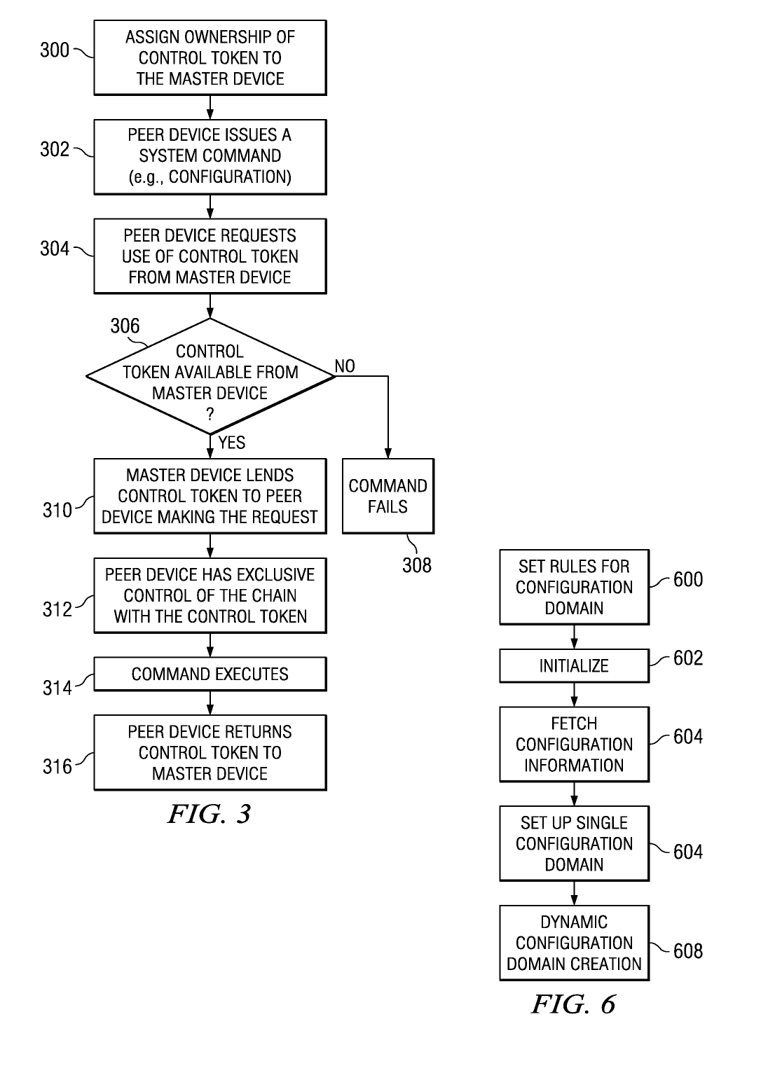

FIG. 3 shows a flow chart of a high-level method for detection and management of daisy-chained system topology in accordance with one or more embodiments. The method for control token-based management begins with a master device being assigned ownership of a control token (block 300). Each time the system topology is re-discovered, as described in related U.S. patent application Ser. No. ______, filed ______ 2006, entitled “Device and Method for Discovery, Detection, and Management of Daisy-chained System Topology,” by Tushara Swain (Attorney Docket No. TI-39462), and U.S. patent application Ser. No. ______, filed ______ 2006, entitled “Control Token Based Management of Daisy-chained System Topology,” by Tushara Swain (Attorney Docket No. TI-39923), preferably one boundary device in the chain is determined to be the master device, and the master device in the newly discovered system topology becomes the owner of the control token. In an illustrative embodiment, for example, the master device is determined to be the master device because it is the boundary device (of two boundary devices) having the lesser Media Access Control (“MAC”) address. The control token is used in management of the daisy-chain system as a single virtual device, as the control token ensures uniformity and synchronization of command execution across the devices of the daisy-chain system, such as configuration command execution.

In block 302, a peer device issues a system command, such as a configuration command to alter the configuration of devices in the daisy-chain system. In order to execute the system command, the peer device requests use of the control token from the master device (block 304). A check is performed by the peer device to determine whether the control token is available from the master device at block 306. An example of the control token being unavailable is when another peer device has already requested and is using the control token. The system command fails if the control token is not available from the master device (block 308).

If the control token is available from the master device, the master device lends the control token to the peer device making the request (block 310). The peer device thus has exclusive control of the daisy-chain system while it has use of the control token (block 312), and the command executes (block 314). When the command is completed (e.g., configuration for each device in the daisy-chain system has been accomplished), the peer device returns the control token to the master device (block 316).

The obtaining and releasing of the token device is performed in the form of PDU exchanges. Similarly, the execution of configuration APIs and status of execution is also performed in the form of packet PDU exchanges.

### Auto-Configuration Method

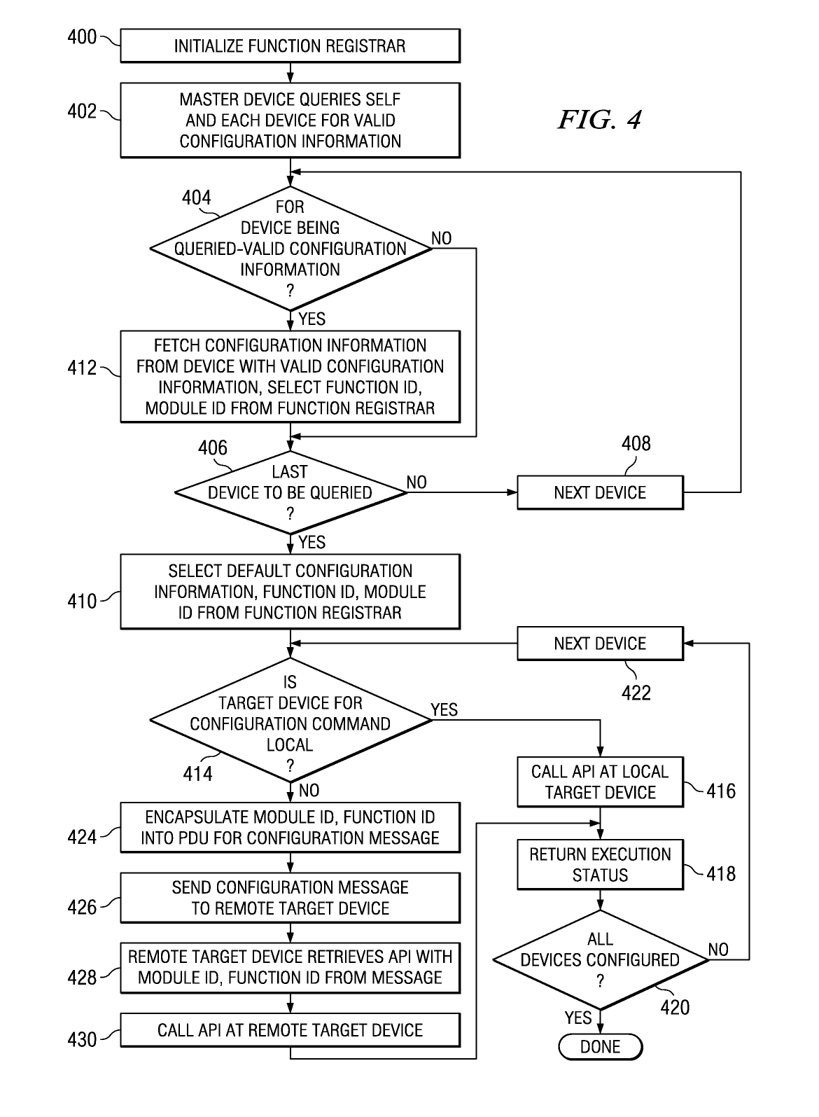

Referring now to FIG. 4, a flow chart is shown for a method of auto-configuring devices in a daisy-chain system in accordance with one or more embodiments. The method begins at block 400 with initializing the function registrar 208. Initialization may include loading functions according to a function index by function identity and module identity. Initialization may alternatively include reloading functions and/or adding functions. With the function registrar 208 initialized, the master device (i.e., a selected boundary device) queries itself and each other device in the chain to determine which device(s) have valid configuration information stored in the storage 108, 112, 116, etc. (block 402).

Moving down the chain one device at a time, the master device determines if the device being queried has valid configuration information (block 404). If not, the master device determines whether the device being queried is the last device to be queried in the system (block 406). If the device is not the last device to be queried, the master device proceeds to the next device in the chain (block 408), returning to block 404 to evaluate the configuration information for the next device in the chain. If the device is the last device to be queried and the master device has not yet found valid configuration information, the master device selects default configuration information, including a function identifier and a module identifier, from the function registrar 208 (block 410) that can be used to create a common configuration domain in the system.

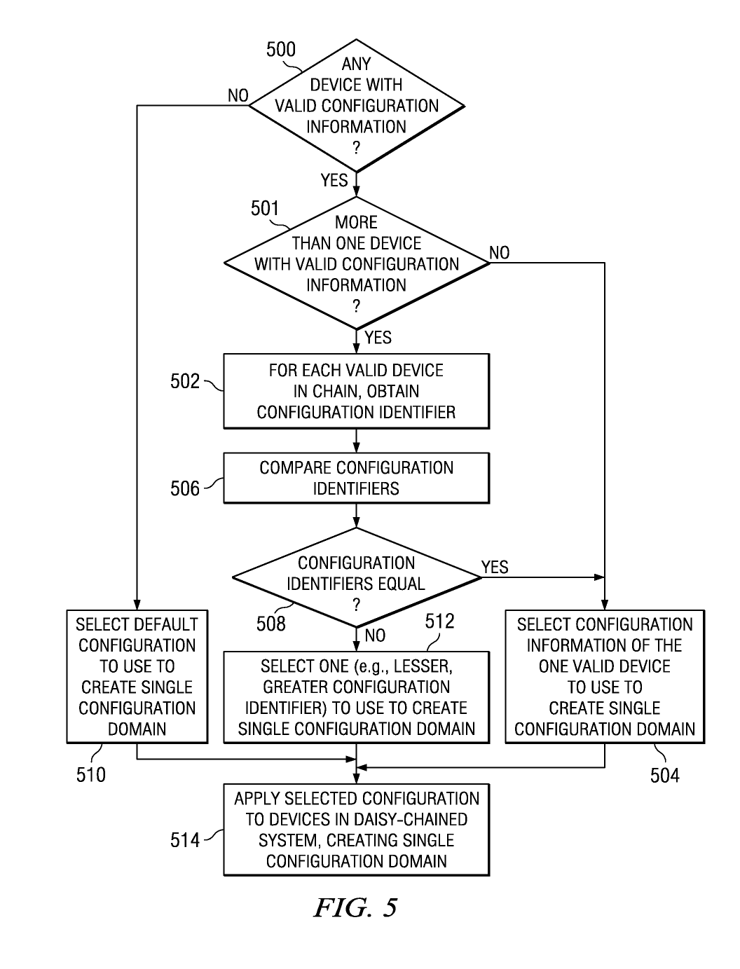

Returning to block 404, if the device being queried does have valid configuration information, the master device fetches configuration information from the device with valid configuration information, and selects the function id and module id from the function registrar 208 (block 412). The module identifier and function identifier may be used to create a common configuration domain for the system, wherein parameters of the configuration are targeted to one or more other devices in the daisy-chain system. In some embodiments, more than one device in the daisy-chain system may store valid configuration information, which will be described with respect to FIG. 5.

Having found valid configuration information and obtained a module identifier and function identifier, the master device then targets each device in the chain, in turn, for auto-configuration (i.e., without manual intervention by a system user or administrator) using the valid configuration information. At block 414, the master device determines whether a target device targeted for a configuration command is local. If the target device is local, the master device calls an API at the target device with the configuration information, and the processor 200 of the target device executes the configuration command (block 416). The device returns the execution status, reflecting that the configuration command successfully executed (block 418). The master device determines whether all the devices have been configured (block 420), and if yes, the method is complete, but if no, the master device advances to the next device in the chain (block 422).

Returning to block 414, if the device targeted for configuration is not local, the master device encapsulates the module identifier and the function identifier into a Protocol Data Unit (“PDU”) for a configuration message (block 424), and sends the configuration message to the remote target device (block 426). When the target device receives the configuration message, the target device retrieves the API using the module identifier and function identifier from the message (block 428). The target device then calls the API, and the processor 200 executes the configuration command (block 430). The device returns the execution status, reflecting that the configuration command successfully executed (block 418). The master device determines whether all the devices have been configured (block 420), and if yes, the method is complete, but if no, the master device advances to the next device in the chain (block 422).

### Obtaining Configuration Information for Creating Common Configuration Domain

Referring now to FIG. 5, a flow chart is shown for a method of obtaining valid configuration information from one or more devices in the daisy-chained system, and establishing a common configuration domain by applying the valid configuration information across the system to each device. The master device determines whether there are any valid devices (block 500). If there are not any valid devices in the system, the master device selects a default configuration stored at the master device to use in creation of a common configuration domain (block 510). If there are any valid devices at block 500, the master device determines whether there is more than one device with valid configuration information (block 501). If there is not more than one valid device at block 501, the master device selects the configuration information from the one valid device to use in creation of a common configuration domain (block 504).

If there is more than one valid device at block 501, the master device obtains a configuration identifier for each device in the chain having valid configuration information, i.e., each valid device (block 502). A configuration identifier is a string that may be retrieved from the storage 108 that identifies how various parameters are set for the configuration. The master device compares configuration identifiers for the valid devices (block 506), and determines whether the configuration identifiers are equal (block 508). If the configuration identifiers are equal the master device selects the configuration information from one valid device, since the configuration identifiers are equal the configurations are similar, to use in creation of a common configuration domain (block 504). If the configuration identifiers are not equal, the master device selects a default set of configuration information to use in creation of the common configuration domain (block 510).

The configuration information selected at block 504 or block 510 is then used by the master device for automatically configuring devices in the daisy-chained system without requiring any manual interaction by a user (block 512). A common configuration domain is accomplished by applying the same configuration information for each device in the system, such that each device is configured identically or similarly to the others.

Referring now to FIG. 6, a flow chart is shown for an illustrative embodiment of a method of auto-configuring a system of daisy-chained ethernet-based devices, such as Internet Protocol telephones. For auto-configuration of devices in a daisy-chained system, valid configuration information is fetched from one of the devices, and the other devices in the chain are automatically configured according to the fetched configuration information and rules derived for each parameter of the configuration domain. The method begins as rules are entered and set for a common configuration domain (block 600). Rules may vary, depending on the type of devices in the system. For illustrative purposes here, the devices are Internet Protocol telephones, and therefore, illustrative rules for the configuration domain pertain to configuration of IP phones in a LAN. For example, such a rule may include when a LAN port (port 1 on device 102 of FIG. 1) with a virtual port (port 3 on device 102 of FIG. 1) is made a member of any virtual LAN (“VLAN”), each internal port in the chain of devices is also made a member of the same VLAN. Another illustrative rule is for each Port VLAN Identifier, the same configuration is applied to each device in the chain. Still another illustrative rule is the same priority configuration is applied across the devices in the chain except for internal ports; internal ports are transparent to any priority changes of the packet. Still another illustrative rule is that multicast addresses are registered for each port of a VLAN and for forward all ports the same configuration is applied across the devices in the chain. Another illustrative rule is that the same port configuration (i.e., speed/Duplex mode) is applied across the devices in the chain except for internal ports, which are configured as auto-negotiating. Once the rules are set, no further manual interaction is required from a user for configuration as the system is now operable for auto-configuration.

The system is initialized, which may include adding a device, removing a device, or powering off or on any number of devices in the chain (block 602). With any change in the daisy-chain topology, the stacking protocol re-discovers the topology, as described in related U.S. patent application Ser. No. ______, filed ______ 2006, entitled “Device and Method for Discovery, Detection, and Management of Daisy-chained System Topology,” by Tushara Swain (Attorney Docket No. TI-39462). When the topology has been rediscovered and is known, the method continues with the master device fetching and selecting valid configuration information (block 604). In various embodiments, the fetching is done in accordance with the method described above with respect to FIG. 5.

Using the selected valid configuration information and the rules set up, the master device creates a common configuration domain by automatically applying the valid configuration information and the rules to each device in the system (block 606). Applying the valid configuration information to each device may be accomplished using encapsulated PDU packets to transfer the valid configuration information into storage 108 for each device. When a common configuration domain is created, the configuration information and configuration identifier may be stored in each local device.

At block 608, dynamic configuration domain creation may be accomplished. Dynamic refers to real-time changes made to an existing common configuration domain, such as that established in block 606. Changes to an existing common configuration domain may be made, for example, by modifying or adding at least one parameter of the configuration information, or entering a change to the rule. When any parameter is modified or added, the rule for that parameter is applied across the daisy-chained system in block 606.

Inasmuch as the systems and methods described herein were developed in the context of a LAN, the description herein is based on a LAN computing environment. However, the discussion of the various systems and methods in relation to a LAN computing environment should not be construed as a limitation as to the applicability of the systems and methods described herein to only LAN computing environments. One of ordinary skill in the art will appreciate that these systems and methods may also be implemented in other computing environments such as Personal Area Networks (“PANs”), Wide Area Networks (“WANs”), Metropolitan Area Networks (“MANs”), and other networks.

The above discussion is meant to be illustrative of the principles and various embodiments of this disclosure. Numerous variations and modifications will become apparent to those skilled in the art once the above disclosure is fully appreciated. For example, the scope of disclosure is not limited to daisy-chained systems of IP telephones, as illustrated herein. The method and system for auto-configuration and a common configuration domain may be extended to any type of daisy-chained ethernet-based devices. It is intended that the following claims be interpreted to embrace all such variations and modifications.

1. A method of auto-configuration, the method being performed in a daisy-chain system of a plurality of serially inter-connected devices, the method comprising:
receiving at least one rule for a configuration domain;
fetching configuration information from at least one device in the daisy-chain system;
defining the configuration domain based on the at least one rule and the configuration information; and
applying the configuration domain to each device in the daisy-chain system.

2. The method of claim 1, further comprising:
detecting a daisy-chain system topology change; and
propagating the daisy-chain system topology change to each device in the daisy-chain system of serially inter-connected devices;
wherein the daisy-chain system topology change comprises at least one of 1) an additional device is added to the daisy-chain system, 2) a device in the daisy-chain system is removed, 3) a device in the daisy-chain system is powered on, and 4) a device in the daisy-chain system is powered off.

3. The method of claim 2, further comprising:
dynamically updating the configuration domain; and
reapplying the updated configuration domain to each device in the daisy-chain system.

4. The method of claim 1, further comprising initializing the daisy-chain system to initiate the fetching of configuration information.

5. The method of claim 1, wherein fetching configuration information further comprises determining if any devices in the daisy-chain system have valid configuration information stored therein, and if not, selecting default configuration information.

6. The method of claim 5, further comprising:
if any devices in the daisy-chain system have valid configuration information stored therein, determining if more than one device has valid configuration information stored therein, and if not, selecting the configuration information for the one device having valid configuration information; and
fetching the selected configuration information from a storage in the device associated with the selected configuration information.

7. The method of claim 5, further comprising:
if more than one device has valid configuration information stored therein, comparing configuration identifiers and selecting one device's configuration information based on the comparison; and
fetching the selected configuration information selected from a storage in the device associated with the selected configuration information.

8. The method of claim 1, wherein applying the configuration domain to each device in the daisy-chain system further comprises:
querying a function registrar; and
executing an API on a target device, thereby configuring the target device with the same configuration information.

9. The method of claim 1, further comprising determining which device of the plurality of serially inter-connected devices is a master device.

10. The method of claim 9, wherein applying the configuration domain to each device in the system is performed by the master device.

11. The method of claim 9, wherein applying the configuration domain to each device in the system is performed by a peer device other than the master device, wherein the peer device requests use of a control token from the master device in order to gain the ability to apply the configuration domain to each device in the daisy-chain system.

12. A daisy-chain system, comprising:
a plurality of auto-configuring devices serially inter-connected together as a daisy-chain system, wherein one device of the plurality of auto-configuring devices is a master device;
each auto-configuring device comprising:
an ethernet switch having at least two ports;
a control logic that:
receives at least one rule for a configuration domain;
fetches configuration information from at least one device in the daisy-chain system;
defines the configuration domain based on the at least one rule and the configuration information; and
applies the configuration domain to each device in the daisy-chain system.

13. The daisy-chain system of claim 12, wherein the control logic is further operable to:
detect a daisy-chain system topology change; and
propagate the daisy-chain system topology change to each device in the daisy-chain system of serially inter-connected devices;
wherein the daisy-chain system topology change comprises at least one of 1) an additional device is added to the daisy-chain system, 2) a device in the daisy-chain system is removed, 3) a device in the daisy-chain system is powered on, and 4) a device in the daisy-chain system is powered off.

14. The daisy-chain system of claim 13, wherein the control logic is further operable to:
dynamically update the configuration domain; and
reapply the updated configuration domain to each device in the daisy-chain system.

15. The daisy-chain system of claim 12, wherein the control logic is further operable to initialize the system to initiate the fetch of configuration information.

16. The daisy-chain system of claim 12, wherein in fetching configuration information, the control logic is further operable to:
determine if any devices in the chain have valid configuration information stored therein, and if not, the control logic selects default configuration information;
and
fetch the selected configuration information from a storage in the device associated with the selected configuration information.

17. The daisy-chain system of claim 16, wherein, if any devices in the chain have valid configuration information stored therein, in fetching configuration information, the control logic is further operable to determine if more than one device has valid configuration information stored therein, and if not, the control logic selects the configuration information for the one device having valid configuration information.

18. The daisy-chain system of claim 16, wherein, if more than one device has valid configuration information stored therein, in fetching configuration information, the control logic is further operable to compare configuration identifiers and selecting one device's configuration information based on the comparison.

19. The daisy-chain system of claim 12, wherein in applying the configuration domain to each device in the daisy-chain system, the control logic is further operable to:
query a function registrar; and
execute an API on a target device, thereby configuring the target device with the same configuration information.

20. The daisy-chain system of claim 12, wherein the control logic is further operable to determine if the device of the plurality of serially inter-connected devices is a master device, wherein the fetch of configuration information and application of the configuration domain is performed exclusively by the control logic of the master device.

21. The daisy-chain system of claim 12, wherein each device comprises an Internet Protocol (IP) telephone.

22. An auto-configuring device, comprising:
an ethernet switch having at least two ports;
a storage storing configuration information
a control logic operable to:
receive at least one rule for a configuration domain;
fetch configuration information from the storage;
define the configuration domain based on the at least one rule and the configuration information; and
forward the configuration domain to any external device operably coupled to the device by one of the ports.

23. The device of claim 22, wherein the control logic is further operable to:
detect a daisy-chain system topology change;
propagate the daisy-chain system topology change to any external device operably coupled to the device by one of the ports;
dynamically update the configuration domain; and
reapply the updated configuration domain to each device in the daisy-chain system;
wherein the daisy-chain system topology change comprises at least one of 1) an additional device is added to the one of the ports, 2) a device coupled to one of the ports is removed, 3) a device coupled to one of the ports is powered on, and 4) a device coupled to one of the ports is powered off.

24. The device of claim 22, wherein the control logic is further operable to initialize the device to initiate the fetch of the configuration information from the storage

25. The device of claim 24, wherein the control logic comprises:
a stacking protocol operable to discover a topology of a daisy-chain system in which the device functions;
a function registrar that maintains a store of configuration command functions;
a virtual device manager that stores configuration information relating to the device;
wherein in applying the configuration domain to each device in the daisy-chain system, the control logic is further operable to:
query the function registrar; and
execute an API on a target device coupled to the device via one of the ports, thereby auto-configuring the target device with the fetched configuration information.
